(19) United States
(12) Patent Application Publication
(10) Pub. No.: US 2025/0345886 A1
(43) Pub. Date: Nov. 13, 2025

(54) SPLASH-GUARD DEVICE AND LASER WELDING APPARATUS EQUIPPED THEREWITH

(71) Applicant: GROB-WERKE GmbH & Co. KG, MINDELHEIM (DE)

(72) Inventors: Jochen KERLER, EPPISHAUSEN (DE); Patrick HIERL, DIRLEWANG (DE); Michael RATHGEB, AUGSBURG (DE)

(21) Appl. No.: 19/205,258

(22) Filed: May 12, 2025

(30) Foreign Application Priority Data
May 13, 2024 (EP) 24175351.6

(51) Int. Cl. B23K 26/70

(52) U.S. Cl. CPC B23K 26/706

(57) ABSTRACT

A splash-guard device for a laser welder for contact elements for electrical contacting. The deice has a pressure piece for pressing onto the component to be welded, and a spatter guard. The pressure piece has a pressure piece body with a laser beam outlet mouth, the edge of which surrounds the welding point when pressed on. The spatter guard is designed as an angled tube, the first end of which is sealed off from the pressure piece and the second end of which is designed as a connection for an extraction system. At least one laser beam entry opening is formed on an angled or curved region which is opposite the first end having the pressure piece. Also, a laser welder with such a splash-guard device.

### CROSS-REFERENCES TO RELATED APPLICATIONS

This application claims the benefit of European Patent Application Number 24175351.6 filed on May 13, 2024, the entire disclosure of which is incorporated herein by way of reference.

### FIELD OF THE INVENTION

The invention relates to a splash-guard device for a laser welding apparatus for laser welding of contact elements for electrical contacting. The invention further relates to a laser welding apparatus connected thereto.

The invention resides in the field of laser welding. The preferred field of application for devices and apparatus according to embodiments of the invention is the field of battery cell production. Devices and apparatus according to the invention are preferably used for CCS welding of battery cells (CCS is an abbreviation for cell contacting system(s)).

### BACKGROUND OF THE INVENTION

For the technological background, reference is made to the following literature:
[1] WO 2022/156800 A1
[2] CN 215698852 U1
[3] CN 115958290 A1
[4] https://www.youtube.com/watch?v=-vLVN27VMpk

References [1] and [2] show laser welding devices for CCS welding of battery cells.

Cell contacting systems (CCS) connect individual battery cells to form a battery module. According to the so-called “Cell2Pack” principle, the battery cells are processed directly into the battery pack. The CCS contacting with the battery cells is currently generally carried out using a laser welding process (CCS welding). Technically contaminated battery cells have significantly reduced performance and service life.

The following approaches are currently being pursued to avoid contamination from welding spatter:

Laser welding process under protective gas atmosphere;
Use of air-blowing cleaning (cross jets) to protect the protective glass of the optics;
Use of air-blowing cleaning (cross jets) to protect the component from welding spatter; and,
Use of process extraction systems to capture and remove welding spatter.

All previous solutions have various disadvantages. For example, injecting blowing air by cross jets can lead to large-scale distribution or emission of particles in the system. The contamination of adjacent welded joints is particularly critical in this case. Despite the use of air-blowing cleaning, a significant contamination of the optics and components can often occur. In particular, there is no protection of the component against spatter.

In some previous solutions, the extraction system does not capture all welding spatter. Known solutions are not suitable for an “on-the-fly” laser welding process, i.e., for laser optics which are stationary only during the welding process.

Some previous solutions have an insufficient protective gas atmosphere at the welding site itself.

The solution known from [4] does provide spatter protection, but this is much too low and open and therefore inadequate. Welding spatter can escape unhindered. There is no object detection and therefore no detection of welding spatter. In addition, no blowing-air device is provided; if blowing air were used, the welding spatter would only be blown further away onto the component. Furthermore, the protective gas atmosphere is insufficient; protective gas is supplied from a considerable distance away, so that there is probably no protective gas left at the welding site itself.

### SUMMARY OF THE INVENTION

It is an object of the invention to provide apparatus and devices which enable improved laser welding of contact elements for electrical contacting and, in particular, reduce contamination by welding spatter.

This object may be achieved by the present invention with a splash-guard device according to one or more embodiments described herein. A laser welding apparatus equipped with such a splash-guard device is also described herein.

The invention provides a splash-guard device for a laser welding apparatus for laser welding of contact elements for electrical contacting, comprising:
a pressure piece for pressing onto the component to be welded, and a spatter guard,
wherein the pressure piece has a pressure piece body with a laser beam outlet mouth, the edge of which surrounds the welding point when pressed on, and
wherein the spatter guard is designed as an angled tube, the first end of which is sealed off from the pressure piece and the second end of which is designed as a connection for an extraction system, wherein at least one laser beam entry opening is formed on an angled or curved region opposite the first end having the pressure piece.

In particular, the pressure piece is designed to be pressed onto the component to be welded during operation, in particular in such a way that the pressure piece rests on the component to be welded so as to be at least partially sealing.

In some embodiments, the splash-guard device has an air flow generating device for generating a targeted air flow from the welding point toward the extraction system in order to specifically remove and extract welding spatter.

In some embodiments, the targeted air flow can be generated due to the extraction, for example by sucking in secondary air at the bottom of the pressure piece, and/or by supplying the blowing air. In addition, or alternatively, openings for sucking in air from outside, so-called after-flow openings, can be provided in and/or above the pressure piece. The after-flow openings are designed to suck air from outside into the spatter guard (via the flow effect of the extraction). The after-flow openings are designed in particular so that they are small enough to prevent welding spatter from escaping to the outside through the after-flow openings, but large enough (and/or present in sufficiently large numbers) to allow sufficient air from outside to be sucked into the spatter guard.

The arrangement of the after-flow openings in and/or above the pressure piece is provided above a protective gas supply to the interior of the pressure piece, in particular in the immediate vicinity of a welding point, so that the protective gas is not directly extracted (along) with the airflow generated by the air sucked in through the after-flow openings. In other words, the after-flow openings are arranged as far down as possible in and/or above the pressure piece in order to generate a defined air flow that reliably transports welding spatter away from the welding position. At the same time, however, the after-flow openings must also be positioned high enough so that the air flow generated by the after-flow opening does not entrain the protective gas and thus transport it away from the welding point.

In some embodiments, it is provided that at least one air inlet opens into the spatter guard in an intermediate region that is arranged between the angled or curved region and the pressure piece. This makes it possible to discharge the welding spatter directly towards the extraction system. In addition, this arrangement ensures that virtually all of the welding spatter is captured by the extraction system.

In some embodiments, it is provided that at least one air inlet terminates with at least one directional component tangentially to an inner wall of the spatter guard. A tangential air flow has less swirls than a non-tangential air flow and can thus improve the flow within the spatter guard.

In some embodiments, it is provided that at least one air inlet is formed at the end of an air duct that is integrally formed in a wall of the spatter guard. The integral design in the wall of the spatter guard allows decentralized placement of the air connection and thus air exit on the opposite side where only limited space is available.

In some embodiments, it is provided that at least one air inlet terminates with at least one directional component transversely to the at least one laser entry opening in order to form an air curtain in front of the laser entry opening. The air curtain can reduce or even prevent the escape of welding spatter and contamination of or damage to the protective glass of the laser optics and/or the workpiece.

Some embodiments of the splash-guard device have a blowing air device that is designed to blow air through the air inlet. In addition or alternatively, the splash-guard device may have openings, so-called after-flow openings, at the bottom of the pressure piece through which, for example, secondary air can be sucked in. This allows the supply air into the spatter guard to be increased, thereby generating a differentiated flow behavior of the welding spatter.

In some embodiments, it is provided that the spatter guard is designed as a knee-shaped tube with a knee region as an angled or curved region. This allows the laser optics to be arranged as simply as possible, with the laser beam “from top to bottom” while at the same time enabling extraction. Extraction or discharge from the welding point directly upwards is not possible with that simple an arrangement of the laser optics with laser beam.

In some embodiments, it is provided that an intermediate region of the spatter guard arranged between the angled or curved region and the pressure piece has a concavely curved inner wall and/or an inner wall with an elliptical or circular cross-section. In some embodiments, the geometry of the inner wall is chosen in such a way that dead zones of the flow are avoided. In addition, the flow behavior can be improved, in particular optimized, whereby a deposition of weld splatter that is not captured by the flow can be significantly reduced or even prevented.

In some embodiments, it is provided that the pressure piece has a through-opening for the laser welding beam to pass to the laser beam outlet mouth, wherein an air inlet channel opens with one directional component, which is directed away from the laser beam outlet mouth, obliquely into the through-opening in order to generate an exhaust air flow that leads away from the laser beam outlet mouth. In particular, the through-opening merges smoothly into the laser beam outlet mouth. In other words, it can be said that the laser beam outlet mouth forms an axial end of the through-opening.

In some embodiments, it is provided that the laser beam outlet mouth is arranged eccentrically on the pressure-piece body.

In some embodiments, it is provided that the pressure piece is rotatable and/or can freely change its rotational position. In particular, the rotary piece is rotatable in such a way that the laser beam outlet mouth arranged eccentrically on the pressure piece, and thus also the through-opening in the pressure piece above the laser beam outlet mouth, can be adjusted to different position, in particular predetermined positions.

In some embodiments, it is provided that the pressure piece is driven to rotate by means of a rotary drive.

In some embodiments, it is provided that the spatter guard has multiple laser beam entry openings which are adapted to different, in particular predetermined rotational positions of the pressure piece. In particular, the multiple laser entry openings are designed and arranged such that one each of the laser entry openings together with the laser beam outlet mouth forms a laser beam passage channel in one of the predetermined rotational positions of the rotary piece. In this way, multiple points on the component to be welded can be welded without having to reposition the splash-guard device.

For example, if the spatter guard has two laser entry openings, the rotary piece can be rotatably set between two rotary positions, wherein, in a first rotary position thereof, a first of the two laser entry openings forms a laser beam passage channel with the laser beam outlet mouth arranged on the pressure piece, and in a second rotary position thereof, a second of the two laser entry openings forms a laser beam passage channel with the laser beam outlet mouth arranged on the pressure piece.

In some embodiments, it is provided that the laser beam passage channels formed in this way are provided with separately formed extraction channels, all of which open into a common main extraction pipe. This allows optimum flow conditions for extraction to be created in each laser beam passage channel.

Some embodiments of the splash-guard device have a movement device for moving the spatter guard and/or the pressure piece toward and away from the component to be welded and/or in a transverse direction thereto. The movement device makes it possible to move the spatter guard from one area to the next when there are several areas to be welded on the component to be welded. The movement device also makes it possible to move the spatter guard toward the component to be welded when the welding job starts and away from the component when the welding job is complete. In addition, it is possible to use a control unit to automate the movements of the spatter guard.

Some embodiments of the splash-guard device have a movable bracket to which the spatter guard is attached and secured against rotation by an anti-rotation protection. This allows the spatter guard with the pressure piece to be moved or displaced, in particular relative to the component to be welded, even when the laser optics is stationary, in order to approach multiple welding positions for which the laser beam of the stationary laser optics must be deflected differently.

According to a further aspect, the invention provides a laser welding apparatus for laser welding of contact elements for electrical contacting, in particular for welding contact elements for battery cell contacting; the laser welding apparatus comprising a laser welding source and a splash-guard device according to one of the above configurations.

In some embodiments, the laser welding apparatus has a control unit and is configured to place the laser beam outlet mouth of the pressure piece around a welding point and, by means of the pressure piece, press the component to be welded onto a contact partner and, by means of the laser beam source, direct a laser beam through the at least one laser beam entry opening in the spatter guard and the laser beam outlet mouth in the pressure piece to the welding point and then move the laser beam outlet mouth to the next welding point in order to repeat the process there.

The control unit is equipped in particular with a processor and a memory in which a corresponding computer program with control instructions is loaded.

Some embodiments aim to provide devices and arrangements that enable improved CCS welding in such a way that the batteries manufactured with them have increased performance and service life.

Some embodiments of the invention relate to a device for detecting welding spatter, in particular during CCS welding of battery cells, battery modules, or battery packs.

Preferred embodiments have significantly improved splatter protection compared to known solutions, so that welding spatter is prevented from escaping. Some embodiments provide for detection of the object, i.e., collection or capture, and thus detection of the welding spatter. In some embodiments, a blowing air device is provided, wherein it is further preferred that the blowing air is directed in such a way that welding spatter is kept away from the component. Some embodiments provide a protective gas atmosphere for the welding site.

Particularly preferred embodiments of the invention aim to achieve a process-reliable, component-protecting laser welding process, equivalent to process-reliable capture of all welding spatter.

Preferred embodiments have at least one, several or all of the following advantages:

Ensuring a process-reliable and highly dynamic laser welding process for CCS welding;

Applying operating principles for the requirements and needs of the “on-the-fly” laser welding process for CCS welding;

Implementing the following operating principles/requirements/units in the available space:
Spatter protection;
Blowing device (cross jet);
Movement field for the laser beam; and
Removal of welding spatter via extraction connection; and,

Ability to handle the variety and influence of different types of welding spatter (primarily size and energy) while maintaining consistent capture quality

Preferred embodiments of the invention make it possible to generate a targeted air flow from the welding point to the extraction system in order to specifically remove and extract welding spatter. This reduces or even prevents the accumulation of welding spatter. Contamination of the workpiece and/or impairment of the laser process, in particular due to deposits, can be reduced or even prevented.

In combination with an integrated blowing air device, preferred embodiments of the invention simultaneously ensure reliable component protection by blowing welding spatter into this air flow in a targeted manner, whereby it is reliably extracted and removed.

In preferred embodiments, both elements (component protection and blowing air device) are adapted to ensure optimum conditions and a uniformly distributed blowing air flow as well as comprehensive component protection.

In preferred embodiments, welding spatter is prevented from escaping from the device/apparatus, thus specifically avoiding contamination of the component by welding spatter. In particular, the welding spatter is transported into a filter via the connection of the splash-guard device to the extraction system.

Depending on the laser welding parameters (e.g., spot diameter, travel speed, laser power, material of the welded components), a large number of different welding spatter particles are produced, which differ in shape, size, and energy content, among other things. The principle of the solutions selected in the preferred embodiments of the invention is not limited with regard to the variety of welding spatter, but rather ensures the reliable capture of a wide variety of welding spatter. This can be achieved, for example, but not exclusively, by the following features:
The pressure piece seals the contact with the workpiece;
The laser entry opening(s) is (are) only as large as required by the respective process;
After-flow openings are located as close as possible to the welding point, but at a sufficient distance so that the protective gas is not carried away with the flow;
The number of after-flow openings is set in such a way that the required/desired air flow can be generated;
The after-flow openings are small enough to prevent welding spatter from escaping through them;
The geometry of the spatter device is designed so as not to generate any dead zones for the extraction flow in order to ensure that all welding spatter is removed as far as possible, i.e., to prevent welding spatter from depositing in the spatter device.

In particular, one, several or all of the following advantages can be achieved with preferred embodiments of the invention:
Prevention of contamination of the component by welding spatter;
Implementation of process-reliable removal of welding spatter;
Implementation of a dynamic, component-friendly and component-protecting “on-the-fly” laser welding process with moving laser optics for CCS welding;
Reduction of cycle time; and,
Reduction of space requirements.

### BRIEF DESCRIPTION OF THE DRAWINGS

An embodiment of the invention is explained in more detail below with reference to the accompanying drawings. In the drawings it is shown by:

FIG. 1 a perspective, partly schematic view of an embodiment of a laser welding apparatus with a splash-guard device;

FIG. 2 a section through a spatter guard of the splash-guard device of FIG. 1;

FIG. 3 the section as in FIG. 2, showing the air flows in the spatter guard;

FIG. 4 an enlarged perspective view of the spatter guard;

FIG. 5 a section through the laser welding apparatus during welding at a first welding point according to an exemplary embodiment;

FIG. 6 the laser welding apparatus of FIG. 5 during welding at a second welding point;

FIG. 7 a sectional perspective view of the splash-guard device of the laser welding apparatus according to an exemplary embodiment to illustrate the structure of some of its components;

FIG. 8 a sectional view of the pressure piece according to an exemplary embodiment, with after-flow openings;

FIG. 9a a first perspective view of the pressure piece with after-flow openings according to an exemplary embodiment;

FIG. 9b a second perspective view of the pressure piece with after-flow openings according to an exemplary embodiment;

FIG. 9c a third perspective view of the pressure piece with after-flow openings according to an exemplary embodiment;

FIG. 10 a section through the laser welding apparatus during welding at a first welding point according to an exemplary embodiment;

FIG. 11 a section through the laser welding apparatus of FIG. 10 during welding at a second welding point;

FIG. 12 a sectional perspective view of the splash-guard device of the laser welding apparatus according to an exemplary embodiment to illustrate the structure of some of its components;

FIG. 13a a first sectional view of the spatter guard according to an exemplary embodiment to illustrate the separately formed laser beam passage channels, each of which has an extraction channel;

FIG. 13b a second sectional view of the spatter guard according to an exemplary embodiment to illustrate the separately formed laser beam passage channels, each of which has an extraction channel; and,

FIG. 13c a third sectional view of the spatter guard according to an exemplary embodiment to illustrate the separately formed laser beam passage channels, each of which has an extraction channel.

### DETAILED DESCRIPTION OF THE PREFERRED EMBODIMENTS

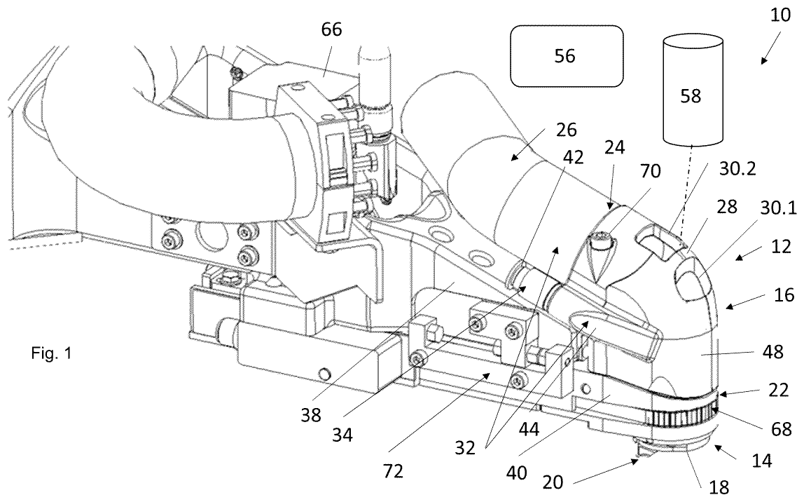

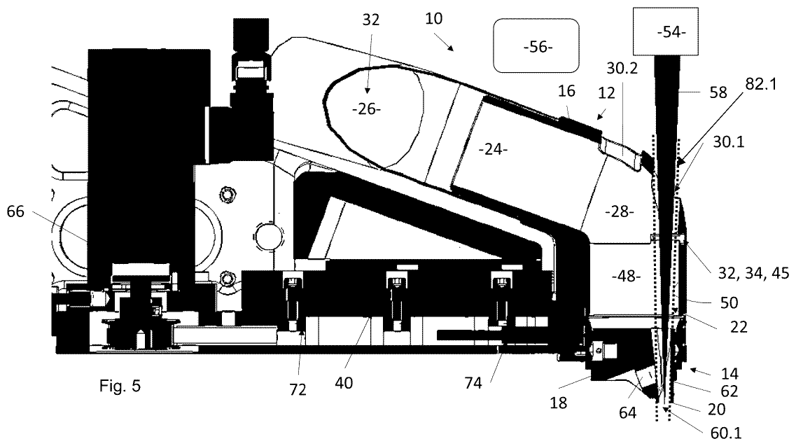

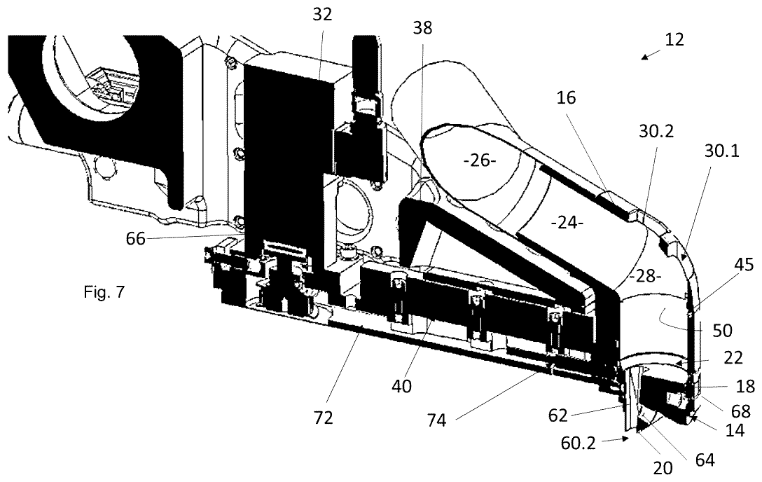

In the following, embodiments of a laser welding apparatus 10 for laser welding of contact elements for electrical contacting-in particular for CCS welding-and a splash-guard device 12 for the laser welding apparatus 10 are explained in more detail with reference to the accompanying Figures. FIGS. 1, 5, and 6 show the laser welding apparatus 10 with the splash-guard device 12, which is also shown separately in FIG. 7.

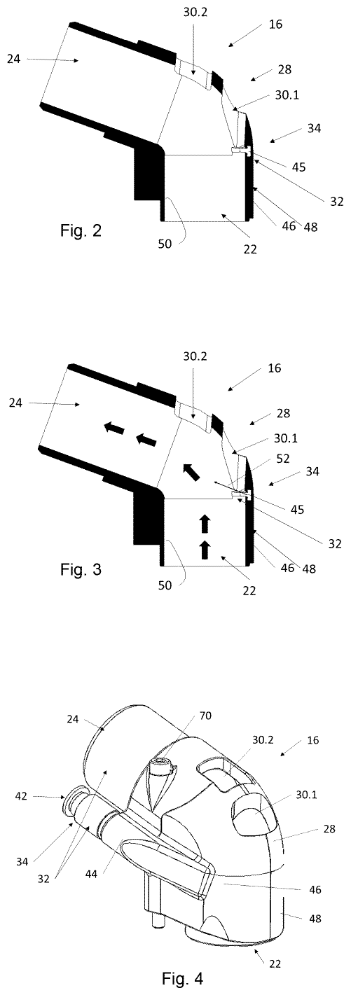

The splash-guard device 12 has a pressure piece 14 for pressing onto the component to be welded and a spatter guard 16 shown in more detail in FIGS. 2 to 3.

According to FIGS. 1 and 5 to 7, the pressure piece 14 has a pressure piece body 18 with a laser beam outlet mouth 20, the edge of which surrounds the welding point 60.1, 60.2 when pressed on. In particular, the edge of the laser beam outlet mouth 20 fits tightly against the component to be welded.

According to all the accompanying Figures, the spatter guard 16 is designed as an angled tube-here in particular as a knee-shaped tube-whose first end 22 is sealed off from the pressure piece 14 and whose second end 24 is designed as a connection for an extraction system 26 which may include a suction pump and tubing. At least one laser beam entry opening 30.1, 30.2 is provided in the spatter guard 16 at an angled or curved region-here, for example, designed as a knee region 28-opposite the first end 22 having the pressure piece 14.

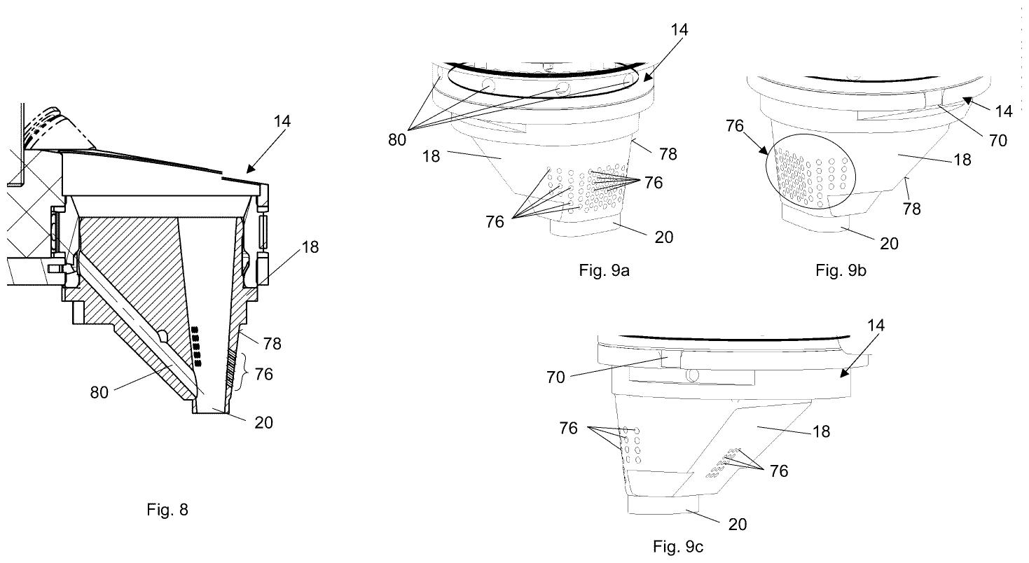

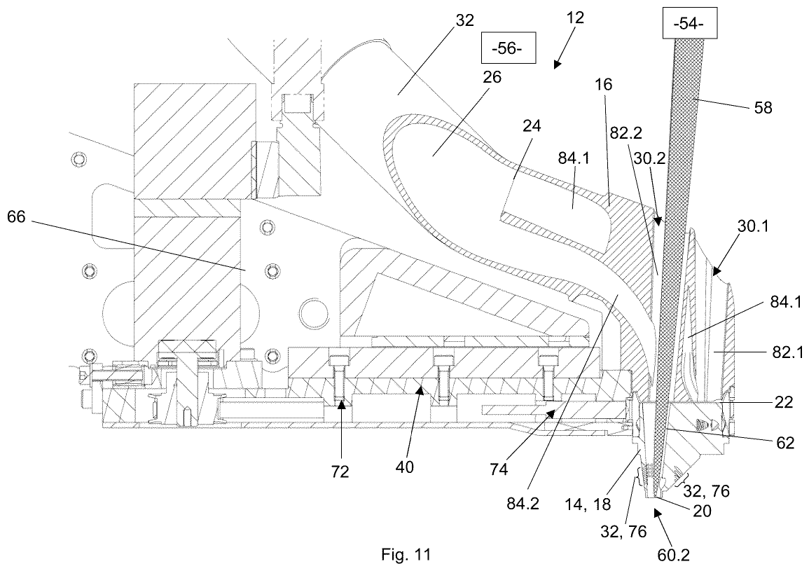

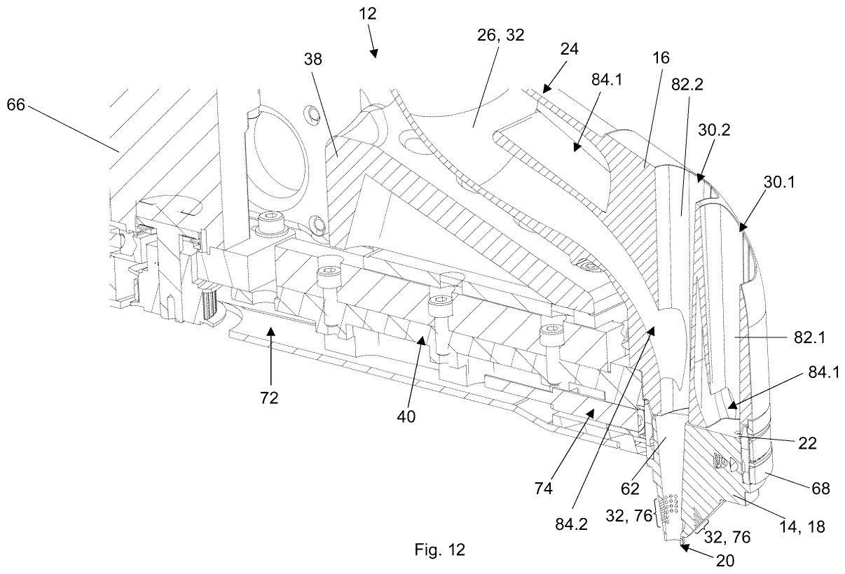

In the exemplary embodiments of the splash-guard device 12 shown, an air flow generating device 32 is also provided for generating a targeted air flow from the welding point toward the extraction system 26 in order to specifically remove and extract weld splatter. In some embodiments, the air flow is generated solely by the suction of the extraction system 26. In other embodiments, the air flow generating device 32 is a blowing air device 34 (see in particular FIGS. 1 to 7), which may be a fan or blower, is additionally provided for generating blowing air. In addition to or as an alternative to the blowing air device 34, after-flow openings 76 may be provided for generating an air flow away from the welding point (see in particular FIGS. 8 to 13).

FIG. 1 shows in particular the spatter guard 16 and its end designed as a connection for the extraction system 26, the pressure piece 14, which is designed to be rotatable here, a stationary bracket 38, a movable bracket 40, and a connection 42 for blowing air, which indicates the blowing air device 34.

The connection 42 for blowing air is formed on an air tube 44, which is integrally formed in a wall 46 of the spatter guard 16. The end of the air tube 44 forms at least one air inlet 45 (outlet opening of the blowing air device 34). The at least one air inlet 45 opens into the spatter guard 16, namely with at least one directional component tangential to an inner wall 50 of the spatter guard, in an intermediate region 48 arranged between the angled or curved region-knee region 28-and the pressure piece 14. In particular, the at least one air inlet 45 opens with at least one directional component transversely to the at least one laser entry opening 30.1, 30.2 in order to create an air curtain 52, as indicated in FIG. 3, in front of the laser entry opening 30.1, 30.2 and thus prevent welding spatter from escaping through the laser entry opening 30.1, 30.2.

The intermediate region 48 of the spatter guard 16 has the concavely curved inner wall 50. In particular, the inner wall 50 in this region 48 has an elliptical or circular cross-section.

FIGS. 1, 5, and 6 show the laser welding apparatus 10, which is equipped with the splash-guard device 12, a laser welding source 54, and a computer-implemented control unit 56. The laser welding apparatus 10 is controlled by the control unit 56 in such a way that a laser welding beam 58 is directed onto the respective welding point 60.1, 60.2.

The pressure piece 14 has a through-opening 62 for the laser welding beam 58 to pass through to the laser beam outlet mouth 20. An air inlet channel 64 opens with a directional component directed away from the laser beam outlet 20 obliquely into the through-opening 62 in order to generate an exhaust air flow leading away from the laser beam outlet mouth 20. The laser beam outlet mouth 20 is arranged eccentrically on the pressure piece body 18. The pressure piece 14 can be rotated by means of a rotary drive 66 controlled by the control unit 56. For example, on the pressure piece 14, a belt pulley 68 is provided which is engaged by a drive belt that is driven by the rotary drive 66. Furthermore, a sensor 74 can be provided for belt breakage monitoring.

Instead of the air inlet channel 64, several openings 76 may also be provided on or above the pressure piece 14, in particular in the immediate vicinity of the laser beam outlet mouth 20 (see FIG. 8 and FIGS. 9a to 9c). These are arranged on a lateral surface 78 of the pressure piece 14 and can be arranged on the lateral surface 78 in a manner distributed in the circumferential direction, as indicated in FIGS. 9a to 9c. The number, size and position of the after-flow openings 76 are selected such that, on the one hand, no welding spatter can penetrate to the outside through the after-flow openings 76 and, on the other hand, the air sucked in from the outside through the after-flow openings 76 generates a sufficient air flow to ensure that the welding spatter is safely removed from the welding point in the direction of the extraction system 26. At the same time, they are arranged in such a way that the protective gas present in the immediate vicinity of the region to be welded is not removed (entrained) by the air flow. In other words, a protective gas is supplied as close as possible to the region to be welded, for example via a protective gas supply device 80 (see FIG. 8), so that the welding process can be carried out under a protective gas atmosphere. The after-flow openings 76 are arranged above the protective gas supply device 80 in such a way that the after-flow openings 76 closest to the protective gas supply device 80, when viewed in a vertical direction, are arranged at a predetermined distance from the protective gas supply device 80, which distance is chosen so that the lowest after-flow openings 76 are arranged as close as possible to the welding point, but far enough away from the protective gas supply device 80 that the protective gas supplied via the protective gas supply device 80 is not transported by the air flow entering through the after-flow openings 76 in the direction of extraction 26.

As can be seen in particular from FIGS. 4, 5, and 6, the spatter guard 16 in the embodiment shown here has at least a first laser entry opening 30.1, which is adapted to a first rotary position of the pressure piece 14, and a second laser entry opening 30.2, which is adapted to a second rotary position of the pressure piece 14.

The pressure piece 14 is rotatably mounted on the movable bracket 40. The spatter guard 16 is secured against rotation on the movable bracket 40, for example by means of an anti-rotation protection 70. The movable bracket 40 forms part of a movement device 72 which is designed to move the spatter guard 16 and the pressure piece 14 toward and away from the component to be welded and/or in a transverse direction thereto.

In particular, the control unit 56, which has a processor and a memory with a computer program loaded therein, is designed to position the laser beam outlet mouth 20 of the pressure piece 14 around a welding point 60.1 and, by means of the pressure piece 14, to press the component to be welded onto a contact partner, in particular in a sealing manner, and, by means of the laser beam source 54, to direct a laser welding beam 58 through the at least one laser beam entry opening 30.1, 30.2 in the spatter guard 16 and through the laser beam outlet mouth 20 in the pressure piece 14 onto the welding point 60.1 and then to move the laser beam outlet mouth 20 to the next welding point 60.2 in order to repeat the process there. The pressure piece 14 is in particular force-controlled in order to ensure a sealing contact between the component to be welded and the pressure piece 14 even in the event of tolerance-related variations in the geometry of the component to be welded and/or the contact partner.

Accordingly, a preferred embodiment of the splash-guard device 12 has several systems that follow operating principles that can be used individually or in combination to prevent contamination of the component by welding spatter produced during laser welding processes.

In the embodiment shown, such systems are provided in particular by the extraction system 26, the air flow generating device 32, such as the blowing air device 34 and/or the after-flow openings 76, and the spatter guard 16.

The extraction system 26 is designed for the process-reliable capture of welding spatter by means of an extraction unit (e.g., suction mechanism, suction fan). In particular, the extraction system 26 serves to remove the welding spatter by creating a local vacuum.

The (optional) blowing air device 34 is designed for targeted blowing of the welding spatter in the direction of the extraction system 26. The blowing air device 34 is designed in particular to prevent welding spatter from escaping through the laser entry openings 30.1, 30.2 in the spatter guard 16 by means of an air curtain 52. In some embodiments not shown, the air flow creating an air curtain can also be generated solely by the suction flow of the suction device.

The (optional) after-flow openings 76 (see in particular FIG. 8 and FIGS. 9a to 9c) are designed to suck in air from outside through the flow of air created in the spatter guard 16 in such a way that the welding spatter near the welding point is transported in a targeted manner toward the extraction system by this air flow. The after-flow openings 76 are designed in such a way that no welding spatter can escape to the outside through the after-flow openings 76.

The spatter guard 16 serves as a structural barrier between the welding process and the remaining component in order to prevent contamination of the component by welding spatter. A downward barrier is provided by the pressure piece 14 which rests on the component during operation and presses the CCS onto the battery module or battery pack.

As shown by way of example in FIGS. 1 to 7, the splash-guard device 12 forms a capture element of the laser welding device 10 which, due to its shape, the integrated and directional blowing device (cross jet) and the connected extraction system 26, has a targeted and directional air flow in the direction of the extraction system 26. Welding spatter is captured by this air flow and guided into the extraction opening-end 24 designed as a connection for extraction.

The spatter guard 16 is connected (plugged) to the movable bracket 40 and secured in position by the anti-rotation protection 70. The laser welding beam 58 from laser optics of the laser beam source 54 is directed onto the component from above downwards through the spatter guard 16 and the pressure piece 14.

The pressure piece 14 can be changed in rotational position under the spatter guard 16, in particular freely. According to exemplary embodiments, the pressure piece 14 is adjustable between rotational positions, in particular predetermined rotational positions. The number of predetermined rotational positions can depend on the number of points to be welded (without having to displace the pressure piece). For the different rotational positions, several laser entry openings, two laser entry openings 30.1, 30.2 in FIGS. 1 to 13c, may be provided in the spatter guard 16.

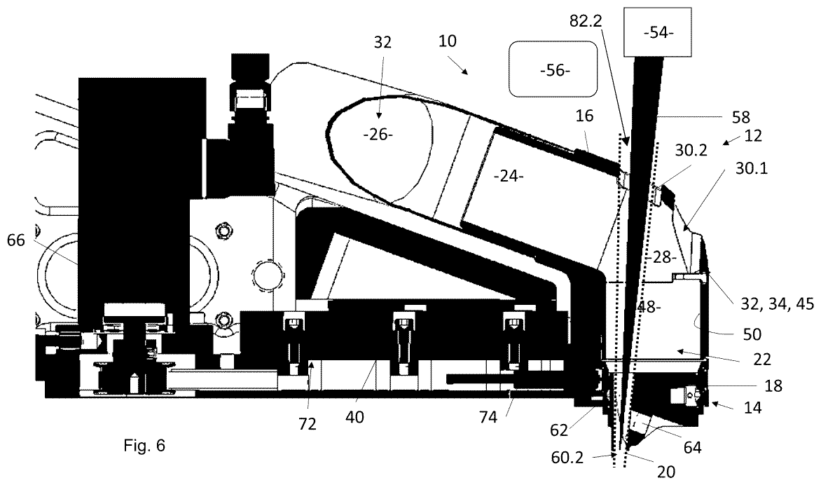

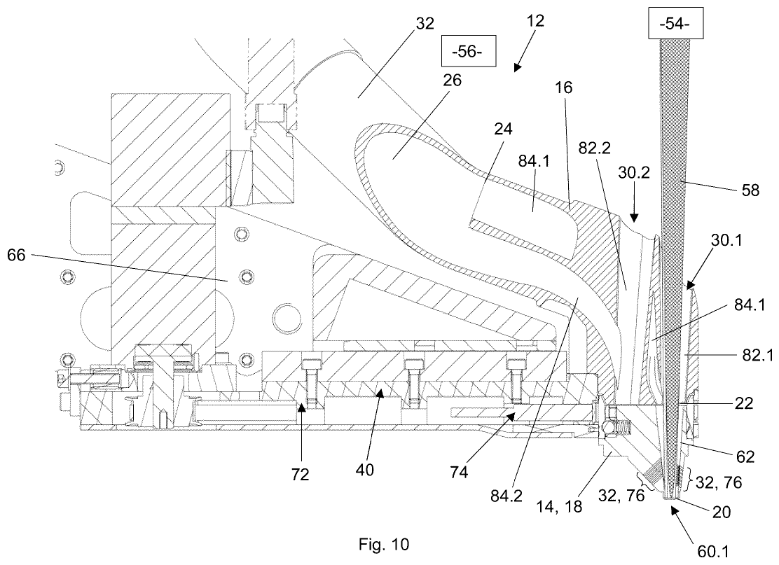

Furthermore, as shown in FIGS. 10 to 13c, it is conceivable that the laser beam entry openings 30.1, 30.2 each open into a laser beam passage channel 82.1, 82.2, which are formed separately from each other in contrast to the “imaginary” laser beam passage channels 82.1, 82.2 indicated by dashed lines in FIGS. 6 and 7. This completely separate design of the laser beam passage channels 82.1, 82.2 makes it possible to provide a separate extraction channel 84.1, 84.2 for each laser beam passage channel 82.1, 82.2. The extraction channels 84.1, 84.2 are designed such that an air flow is generated for each laser beam passage channel 82.1, 82.2, which allows the welding spatter to be transported as optimally as possible, in particular as completely as possible, to the extraction system 26. The laser beam passage channels 82.1, 82.2 open into the passage opening 62 of the pressure piece 14 at the end facing away from the laser beam entry opening 30.1, 30.2, for passing the laser welding beam 58 to the laser beam outlet mouth 20.

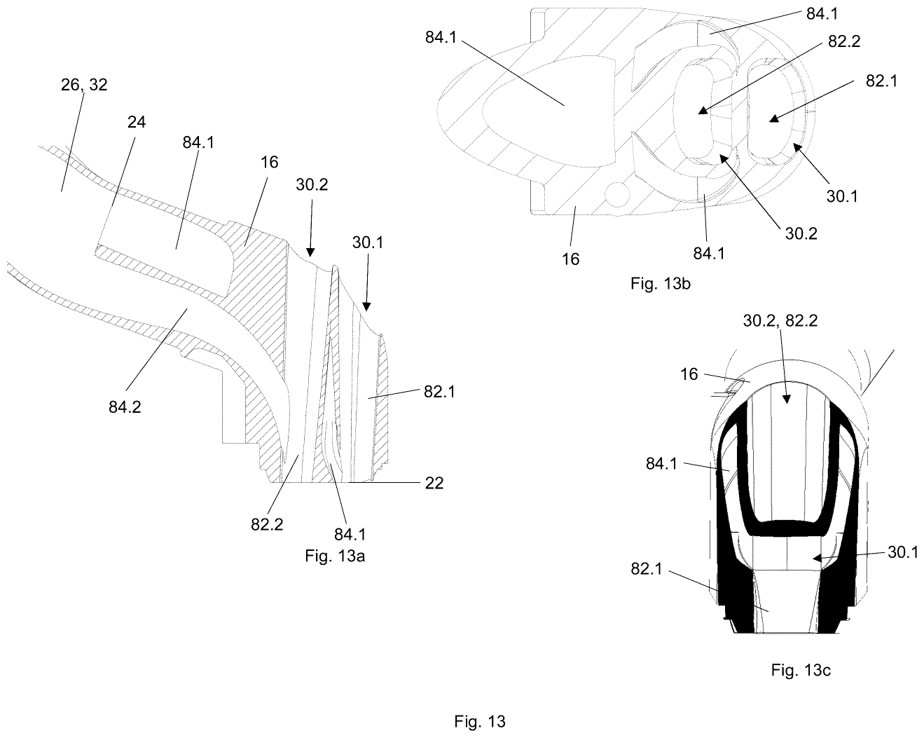

For this purpose, the extraction channel 84.1 of the laser beam passage channel 82.1 is guided laterally past the second laser beam entry opening 30.2 or the second laser beam passage channel 82.2 (see in particular FIGS. 13a to 13c) and to the extraction system 26 above the second suction channel 84.2 (see also FIG. 13a).

The blowing air device 34 is integrated into the spatter guard 16, for example by means of a double-walled design. The blowing air can be applied in a targeted manner at one or more points-air inlet 45 (outlet opening of the blowing air device)-by means of different configurations in order to ensure process-reliable capture and transport of welding spatter away in the direction of the extraction opening.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 laser welding apparatus
12 splash-guard device
14 pressure piece
16 spatter guard
18 pressure piece body
20 laser beam outlet mouth
22 first end
24 second end
26 extraction system
28 knee region
30.1 first laser beam entry opening
30.2 second laser beam entry opening
32 air flow generating device
34 blowing air device
38 stationary bracket
40 movable bracket
42 connection for blowing air
44 air tube
45 air inlet
46 wall
48 Intermediate region
50 inner wall
52 air curtain
54 laser beam source
56 control unit
58 laser welding beam
60.1 first welding point
60.2 second welding point
62 passage opening
64 air inlet channel
66 rotary drive
68 belt pulley
70 anti-rotation protection
72 movement device
74 belt breakage sensor
76 opening (after-flow opening)
78 lateral surface
80 protective gas supply
82 laser beam passage channel
84 extraction channel

Claimed is:

1. A splash-guard device for a laser welding apparatus for laser welding of contact elements for electrical contacting, comprising:
a pressure piece for pressing onto a component to be welded; and
a spatter guard,
wherein the pressure piece has a pressure piece body with a laser beam outlet mouth having an edge surrounding a welding point when pressed on, and
wherein the spatter guard comprises an angled tube with a first end sealed off from the pressure piece and a second end comprising a connection for an extraction system, and,
wherein at least one laser beam entry opening is formed on an angled or curved region of the splatter guard opposite the first end having the pressure piece.

2. The splash-guard device according to claim 1, further comprising:
an air flow generating device for generating a targeted air flow from a welding point towards the extraction system in order to remove and extract welding spatter.

3. The splash-guard device according to claim 1, wherein at least one air inlet opens into the spatter guard in an intermediate region arranged between the angled or curved region and the pressure piece; or
wherein at least one air inlet opens with at least one directional component tangentially to an inner wall of the spatter guard; or
wherein at least one air inlet is formed at an end of an air tube which is integrally formed in a wall of the spatter guard; or
wherein at least one air inlet opens with at least one directional component transversely to the at least one laser beam entry opening in order to create an air curtain in front of the laser entry opening; or
any combination thereof.

4. The splash-guard device according to claim 3, further comprising:
a blowing air device configured to blow air through the air inlet.

5. The splash-guard device according to claim 1, wherein the spatter guard comprises a knee-shaped tube with a knee region as an angled or curved region.

6. The splash-guard device according to claim 1, wherein an intermediate region of the spatter guard arranged between the angled or curved region and the pressure piece has a concavely curved inner wall, or an inner wall with an elliptical or circular cross-section, or both.

7. The splash-guard device according to claim 1, wherein the pressure piece has a through-opening for passing the laser welding beam to the laser beam outlet mouth, wherein an air inlet channel opens with a directional component directed away from the laser beam outlet mouth obliquely into the through-opening in order to generate an extraction air flow leading away from the laser beam outlet mouth, or wherein an intermediate region has a plurality of after-flow openings that are arranged above the laser beam outlet mouth and are configured to draw in air from outside in order to obtain an extraction air flow leading away from the laser beam outlet mouth; or
wherein the laser beam outlet mouth is arranged eccentrically on the pressure piece body; or
both.

8. The splash-guard device according to claim 1, wherein the pressure piece is rotatable, freely changeable, or both in a rotational position; or
wherein the pressure piece is rotatable by a rotary drive; or
both.

9. The splash-guard device according to claim 8, wherein the spatter guard comprises a plurality of laser entry openings which, in at least one rotational position of the pressure piece, form a laser beam passage channel with the laser beam outlet mouth.

10. The splash-guard device according to claim 1, further comprising:
a movement device for moving the spatter guard, the pressure piece, or both toward and away from the component to be welded, or in a transverse direction thereto, or both;
or a movable bracket to which the spatter guard is attached and secured against rotation by an anti-rotation protection; or
both.

11. A laser welding apparatus for laser welding of contact elements for electrical contacting, the laser welding apparatus comprising:
a laser beam source, and
the splash-guard device according to claim 1.

12. The laser welding apparatus according to claim 11, further comprising:
a control unit configured to:
place the laser beam outlet mouth of the pressure piece around a welding point and press the component to be welded onto a contact partner by the pressure piece and,
with the laser beam source, direct a laser beam through the at least one laser beam entry opening in the spatter guard and the laser beam outlet mouth in the pressure piece onto the welding point, and
then move the laser beam outlet mouth to a next welding point in order to repeat the foregoing.
